(19) United States
(12) Patent Application Publication
(10) Pub. No.: US 2011/0260854 A1
(43) Pub. Date: Oct. 27, 2011

(54) POWER SUPPLY HAVING A WIRELESS TRANSMITTER

(76) Inventors: Brian E. Aikens, Garibaldi Highlands (CA); Loren Parfitt, Squamish (CA)

(21) Appl. No.: 12/766,962

(22) Filed: Apr. 26, 2010

(51) Int. Cl. G08B 1/08

(52) U.S. Cl. 340/539.3

(57) ABSTRACT

A power supply having a wireless transmitter includes an input receiving a first voltage from a power source, a power converter operable to convert the first voltage to a second voltage, and an output providing the second voltage to a load. A communication module is operable to receive a data signal from the load via a wired connection. A wireless transmitter is operable to transmit a wireless signal to a receiver in response to the received data signal such that the load is operable to communicate wirelessly with the receiver. A housing forms an enclosure around the power converter, the communication module, and the wireless transmitter.

### BACKGROUND

This disclosure relates to power supplies, and more particularly to a power supply having a wireless transmitter.

Sensors are available that sense a condition and transmit a wireless signal using energy harvested from environmental conditions. However, these sensors are low power devices that have limiting sensing capabilities.

### SUMMARY OF THE INVENTION

A power supply having a wireless transmitter includes an input receiving a first voltage from a power source, a power converter operable to convert the first voltage to a second voltage, and an output providing the second voltage to a load. A communication module is operable to receive a data signal from the load via a wired connection. A wireless transmitter is operable to transmit a wireless signal to a receiver in response to the received data signal such that the load is operable to communicate wirelessly with the receiver. A housing forms an enclosure around the power converter, the communication module, and the wireless transmitter.

A system for communicating sensor data includes a sensor that lacks independent wireless communication functionality. The sensor is operable to transmit a data signal in response to detecting a condition. A power supply is operable to power the sensor, and is operable to transmit a wireless signal in response to receiving the data signal from the sensor.

A method of wirelessly transmitting sensor data encloses a power converter, a communications module and a wireless signal transmitter in a housing. An input voltage is received, the input voltage is converted to an output voltage using the power converter, and the output voltage is provided to a load. A data signal is received from the load to the communications module via a wired connection. A wireless signal is transmitted in response to the received data signal using the wireless signal transmitter such that the wired load is able to communicate wirelessly with the receiver.

These and other features of the present invention can be best understood from the following specification and drawings, the following of which is a brief description.

### BRIEF DESCRIPTION OF THE DRAWINGS

FIG. 1 schematically illustrates a power supply having a wireless transmitter.

FIG. 2 schematically illustrates a more detailed view of the power supply of FIG. 1.

FIG. 3a illustrates a view of an example embodiment of the housing of FIG. 1.

FIG. 3b illustrates another view of the housing of FIG. 2a.

FIGS. 4-7 schematically illustrate a plurality of example loads.

### DETAILED DESCRIPTION

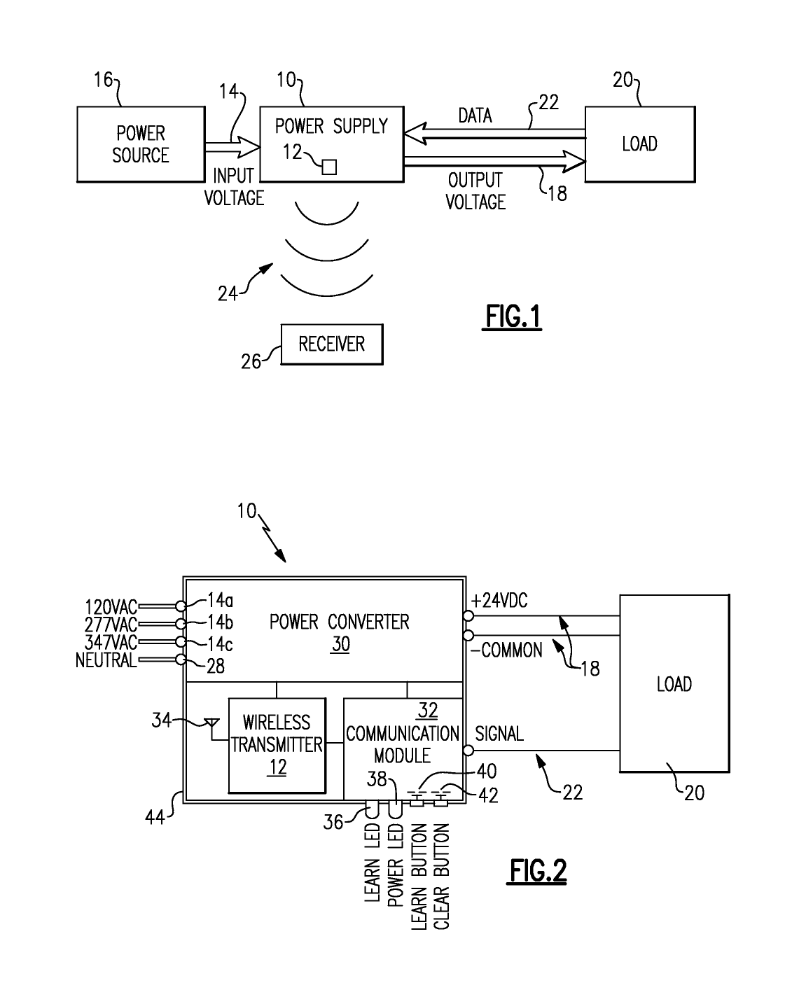

FIG. 1 schematically illustrates a power supply 10 having a wireless transmitter 12. The power supply 10 is operable to convert an input voltage 14 from a power source 16 to an output voltage 18. A load 20 is powered by the output voltage 18. The load may include a sensor such as a motion sensor, a current sensor, or a gas sensor, for example. In one example the load 20 is a sensor that lacks independent wireless communication functionality. The load returns a data signal 22. The data signal 22 may correspond to a sensor sensing a condition, such as motion, electric current, or the presence of a predefined gas beyond a predefined threshold.

The wireless transmitter 12 transmits wireless signal 24 to a receiver 26 in response to the received data signal 22, such that the wired load 20 is able to communicate wirelessly with the receiver 26. Thus, the power supply 10 may be used to retrofit a wired sensor that lacks independent wireless communication functionality for wireless signal transmission.

FIG. 2 schematically illustrates a more detailed view of the power supply 10 of FIG. 1. The power supply 10 includes a neutral input 28 and a plurality of AC inputs 14a-c such that the power converter may receive one of a plurality of different input voltages. Of course, the illustrated input voltages of 120 VAC, 277 VAC, and 347 VAC are only examples, and it is understood that other input voltages 14 and other quantities of input voltages 14 could be used. Power converter 30 receives the input voltage 14 and converts the input voltage 14 to an output voltage 18. In one example the power converter 30 performs an AC/DC conversion such that the input voltage 14 is an AC voltage and the output voltage is a DC output voltage (e.g. 24 VDC). Of course, it is also possible that the power converter 30 may perform an AC/AC conversion or a DC/DC conversion.

As shown in FIG. 2, a communication module 32 receives the data signal 22 from the load 20 and may command the wireless transmitter 12 to transmit the wireless signal 24 in response to receiving the data signal 22. The wireless transmitter 12 includes uses antenna 34 to transmit the signal 24. The power supply 10 also includes a plurality of light-emitting diodes (“LEDs”) 36, 38 and a plurality of buttons 40, 42.

The LEDs 36, 38 and buttons 40, 42 may be used to perform a variety of functions. In one example LED 36 and button 40 are used to perform a “learn” function such that the power supply 10 may become associated with the receiver 26 if the button 40 is pressed, and the LED 36 could turn ON to indicate a successful association. In one example the LED 38 indicates whether the power supply 10 is receiving power from power source 16. In one example the button 42 may be used to clear memory of the communication module 32, the wireless transmitter 12, or both. Also, the blinking patterns of the LEDs 36, 38 may be used to communicate a variety of things, such as whether the load 20 is active, whether a wireless transmitter 12 signal repeating functionality is enabled such that the wireless transmitter 12 is receiving and retransmitting signals from other wireless transmitters 12, etc.

A housing 44 forms an enclosure surrounding the power converter 30, the communication module 32, and the wireless transmitter 12 such that the components 30, 32, 12 are all contained in a single unit. A threaded nipple 46 may be used to secure the power supply 10 into a light bulb socket such that the power supply 10 is secured into the light socket and the light socket acts as the power source 16 (see FIGS. 3a-b).

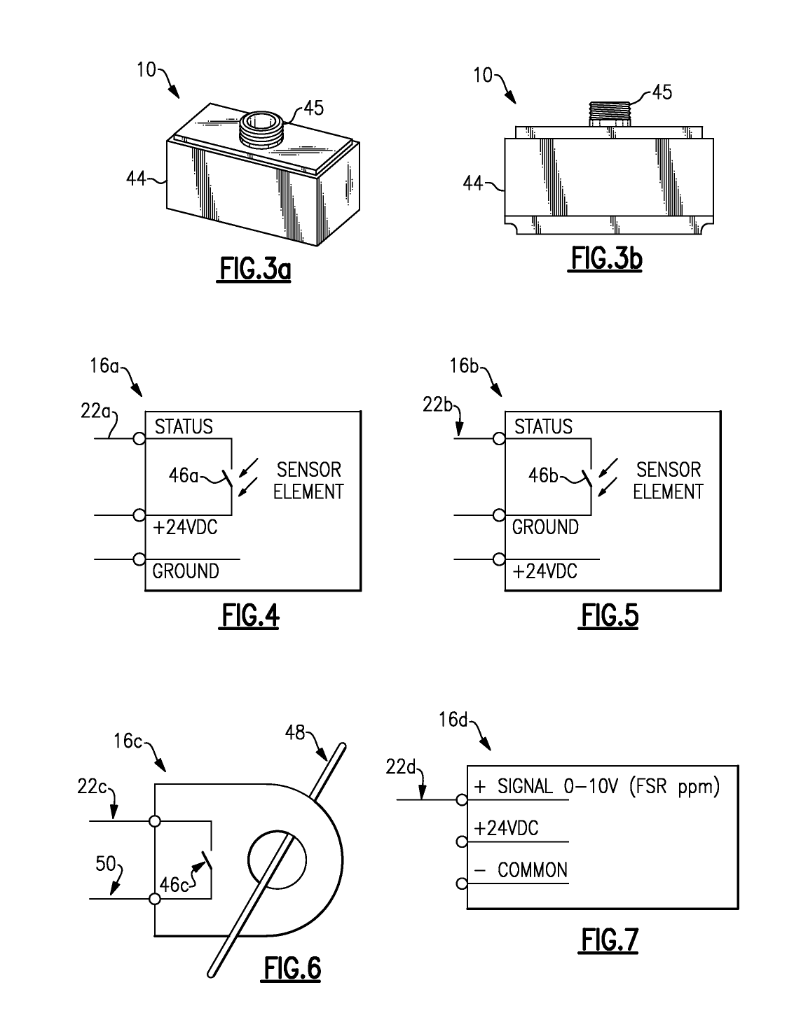

FIGS. 4-7 schematically illustrate a plurality of example loads 20. FIG. 4 schematically illustrates an “active high output” sensor 16a that includes a sensor element 46a configured to transmit data signal 22a as a high output of 24 VDC if a condition is sensed and the sensor element 46a turns ON.

FIG. 5 schematically illustrates an “active low output” sensor 16b that includes a sensor element 46b configured to transmit data signal 22b as a low output connected to ground if a condition is sensed and the sensor element 46b turns ON.

The sensors 46a-b could be motion sensors, for example. Some low voltage motion sensors, such as passive infrared sensors, are only operable to detect “line of sight” motion. Other motion sensors, such as ultrasonic motion sensors, have higher power requirements but are able to detect motion around corners in a building such that a line of sight is not required. Because of the available DC voltage 18, which as discussed above may be 24 VDC, the motion sensors 46a-b could be ultrasonic motion sensors or other motion sensors that have voltage requirements on the order of 24 VDC.

FIG. 6 schematically illustrates an example current sensor load 16c. In response to electrical current flowing through the wire 48, sensing element 46c uses induction to turn ON such that the data signal 22c is connected to input 50. FIG. 7 schematically illustrates an example gas sensor load 16d. In response to levels of a gas (e.g. CO₂) being above a predefined threshold, the sensor 16d connects one of 24 VDC or common to the signal 22d.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A power supply having a wireless transmitter, comprising:
an input receiving a first voltage from a power source;
a power converter operable to convert the first voltage to a second voltage;
an output providing the second voltage to a load;
a communication module operable to receive a data signal from the load via a wired connection; and
a wireless transmitter operable to transmit a wireless signal to a receiver in response to the received data signal such that the load is operable to communicate wirelessly with the receiver; and
a housing that forms an enclosure around the power converter, the communication module, and the wireless transmitter.

2. The power supply of claim 1, wherein the sensor includes at least one of a motion sensor, a current sensor, or a gas sensor.

3. The power supply of claim 1, wherein the second voltage is a direct current voltage.

3. The power supply of claim 1, wherein the first voltage is one of 120 VAC, 220 VAC, 277 VAC or 347 VAC and the second voltage is 24 VDC.

4. The power supply of claim 1, wherein the power converter performs one of an AC/DC or a DC/DC power conversion.

5. The power supply of claim 1, wherein the load lacks independent wireless communication functionality.

6. The power supply of claim 1, including:
a threaded fastener nipple operable to secure the housing to a light socket, wherein the light socket acts as the power source.

7. A system for communicating sensor data, comprising:
a sensor operable to transmit a data signal in response to detecting a condition, the sensor lacking independent wireless communication functionality; and
a power supply operable to power the sensor, and operable to transmit a wireless signal in response to receiving the data signal from the sensor.

8. The system of claim 7, wherein the sensor includes at least one of a motion sensor, a current sensor, or a gas sensor.

9. The system of claim 7, wherein the power supply includes:
an input receiving a first voltage from a power source;
a power converter operable to convert the first voltage to a second voltage; and
an output providing the second voltage to the sensor.

10. The system of claim 9, wherein the power converter performs one of an AC/DC or a DC/DC power conversion.

11. The system of claim 9, wherein the power supply includes:
a housing that forms an enclosure around the power converter, a communication module that receives the data signal, and a wireless transmitter that transmits the wireless signal; and
a threaded fastener nipple operable to secure the housing to a light socket, wherein the light socket acts as the power source.

12. A method of wirelessly transmitting sensor data, comprising:
enclosing a power converter, a communications module and a wireless signal transmitter in a housing;
receiving an input voltage;
converting the input voltage to an output voltage using the power converter;
providing the output voltage to a load;
receiving a data signal from the load to the communications module via a wired connection; and
transmitting a wireless signal in response to the received data signal using the wireless signal transmitter such that the wired load is able to communicate wirelessly with the receiver.

13. The method of claim 12, wherein said receiving a data signal from the load to the communications module via a wired connection includes:
sensing motion; and
transmitting the data signal to the communications module via the wired connection to indicate the sensed motion.

14. The method of claim 12, wherein said receiving a data signal from the load to the communications module via a wired connection includes:
sensing electrical current; and
transmitting the data signal to the communications module via the wired connection to indicate the sensed electrical current.

15. The method of claim 12, wherein said receiving a data signal from the load to the communications module via a wired connection includes:
sensing the presence of a gas exceeding a predefined threshold; and
transmitting the data signal to the communications module via the wired connection to indicate the gas exceeding the predefined threshold.

16. The method of claim 12, including:
inserting a threaded fastener nipple extending from the housing into a light socket;
rotating the housing to secure the housing into the light socket; and
using a threaded fastener using a threaded fastener nipple, wherein said input voltage is received through the light socket.
